(19) United States
(12) Patent Application Publication
(10) Pub. No.: US 2012/0221366 A1
(43) Pub. Date: Aug. 30, 2012

(54) Site Selection Data Analysis and System

(76) Inventors: Charles V. Bowman, Kent, OH (US); Paul DeLuca, Chagrin Falls, OH (US)

(21) Appl. No.: 13/405,636

(22) Filed: Feb. 27, 2012

Related U.S. Application Data
(60) Provisional application No. 61/446,946, filed on Feb. 25, 2011.

(51) Int. Cl. G06Q 10/00

(52) U.S. Cl. 705/7.11

(57) ABSTRACT

A method for site selection data analysis, including providing a distributed computer network for site selection data analysis with a computer and a plurality of databases coupled to a computer network and providing an interface associated with a selected site location for receiving site selection data from the computer. The site selection data may include quantifiable values associated with business operating expenses. The method also includes selectively retrieving rates from a rate database, where the rates are updated dynamically and are selected based on the site location and site selection data. The method also includes providing an algorithm for calculating monthly and annual values of the site selection data and calculating a data set using the algorithm. The method also includes transmitting the data set to the computer to be displayed on a display device and storing the data set and site selection data on a data storage device.

### CROSS-REFERENCE TO RELATED APPLICATIONS

The present invention claims the priority of provisional patent application Ser. No. 61/446,948 filed on Feb. 25, 2011, the disclosure of which is incorporated herein by reference.

### FIELD OF THE INVENTION

The present invention is directed generally to facilitating site selection data analysis in the field of economic development. Specifically, certain embodiments of the present invention relate to web-based methods and systems for calculating and determining comprehensive site selection information within specified municipalities, counties, states or geographic regions.

### BACKGROUND OF THE INVENTION

For an economic region to gain a competitive advantage and align itself regionally, it is imperative that community leaders develop dynamic strategies to stimulate business activity. These strategies may include ways to attract and accommodate the needs of potential business opportunities. Facilitating site selection decision-making can help a community recruit and retain economic development.

Generally, site selection refers to the process of locating and selecting a site location (e.g., the jurisdiction, community or municipality in which the business is to be located) for a business. A decision maker of a business may facilitate the site selection process. The decision maker may be a public or private person seeking site selection information. Before choosing a site location, a decision maker may analyze data on a variety of factors. These factors may include economic data, such as total operating costs for a particular community. The data may come from many sources, in many different forms and may change frequently. Thus, because of the amount and dynamic nature of the data, the process of investigating and selecting a site location can be complicated and tedious. Additionally, the jurisdictions themselves may be interested in what types of businesses are seeking to locate to their jurisdiction. This information can help leaders make strategic decisions to accommodate the needs of prospective businesses and therefore attract and retain business opportunities.

One way for a decision maker to gather data about a site location is to contact each prospect location individually. For example, the decision maker may call an appropriate authority at a jurisdiction. This method is cumbersome, the data is static and the decision maker must manually calculate and analyze the data. Additionally, the authority must specifically ask the decision maker about their business to receive any feedback as what types of businesses are interested in their jurisdiction.

Another way to gather data about each location is through a community website that provides a narrative of tax or utility information. Again, this data is static and the decision maker must process the information into meaningful values to analyze. Some communities may provide a website with a simple estimation form. These websites only estimate one or two types of data. For example, The City of Bedford, Va., provides a combined water and sewer bill estimator. (http://www.bedfordva.gov/utility.shtml). Although useful, these types of websites provide a limited amount of information needed for comprehensive analysis of a new site location. Additionally, these websites do not provide the community with feedback relating to prospective businesses.

Other known methods include U.S. Patent Application Publication US 2009/0083128 which claims a predicated variable analysis based on evaluation variables relating to site selection. This patent describes calculating a predicated variable to evaluate the likelihood of success of an existing business at a new location. A user may enter information relating to sales and revenue and information about multiple existing business locations.

U.S. Pat. No. 7,640,196 claims a method of making capital investment decisions concerning locations for business operations and/or facilities. This patent describes software that lists, based on user-entered criteria, locations for business operations. For example, a user can input economic criteria like state income tax rates, and then the software returns a list of locations matching these criteria.

Although useful, these methods do not provide immediate, comprehensive and current information presented in a format conducive to attracting and retaining economic development opportunities for a particular jurisdiction. Furthermore, these methods fail to provide feedback to the jurisdiction related to the needs of the prospective business.

Accordingly, there is a need for an economic site selection data analysis method and system that provides comprehensive and current information in an accessible and persuasive format, conducive to attracting and retaining economic development opportunities for a particular jurisdiction. Comprehensive site selection data in an accessible and meaningful format will reduce the amount of research needed to determine the exact operating cost in a particular community. Additionally, it would be beneficial for a jurisdiction to be able to gather and analyze data related to site selection business inquiries. This data will be helpful for infrastructure evaluation, planning, budgeting and grant application purposes.

### SUMMARY OF THE INVENTION

The present invention is directed to computer-implemented method for site selection data analysis, including providing a distributed computer network for site selection data analysis where the distributed computer network includes a computer and a plurality of databases each coupled to a computer network. The method further includes providing an interface associated with a selected site location for receiving site selection data from the computer, where the site selection data comprises quantifiable values associated with business operating expenses. Furthermore, the method includes selectively retrieving rates from a rate database, where the rates are selected based on the site location and site selection data, and where the rates are updated dynamically. The method also includes providing an algorithm for calculating monthly and annual values of the site selection data and calculating a data set using the algorithm. The method also includes transmitting the data set to the computer to be displayed on a display device and storing the data set and site selection data on a data storage device.

In another embodiment, the present invention is directed to a computer-implemented method for site selection data analysis, including providing a distributed computer network for site selection data analysis where the distributed computer network includes a computer and a plurality of databases each coupled to a computer network. The method further includes controlling access to an interface by authenticating the computer and permitting access to the interface. The method also includes providing the interface to the computer for receiving at least one site location and site selection data from a user. The site selection data may include water usage, electricity usage, natural gas usage, net profit, property value, wastewater usage, business type and business units.

Furthermore, the method includes selectively retrieving rates from a rate database. The rates are associated with the site location and site selection data, and the rates are updated dynamically. The method also includes providing an algorithm, based on the rates and site selection data, for calculating monthly and annual values of the site selection data and calculating a data set using the algorithm. The method further includes transmitting the data set to the computer to be displayed on a display device and storing the data set and site selection data on a data storage device.

In another embodiment, the present invention is directed to a computing system for site selection data analysis in a networked computing environment including a login logic for authenticating a client and permitting access to an interface for pre-determined jurisdictions. The system also includes a data retrieval logic that retrieves, upon authentication of the client, at least one site location, values associated with business operating expenses, and rates associated with the site location and values from a plurality of databases. The databases are dynamically updated.

Furthermore, the system includes a calculation logic that provides an algorithm based at least upon the values and rates. The calculation logic executes the algorithm to produce a data set. The system also includes a display logic that provides a visual representation of the data set on a display device and a storage logic that stores the data set and values in a data store.

### BRIEF DESCRIPTION OF THE DRAWINGS

The accompanying drawings, which are incorporated herein and constitute a part of the specification, illustrate various example methods, systems and other example embodiments of the invention. It will be appreciated that the illustrated element boundaries (e.g., boxes, shapes) in the figures represent an example of boundaries. One having ordinary skill in the art will appreciate that in some examples one element may be designed as multiple elements and vice versa. Additionally, in some examples, an element drawn as an internal component of another element may be implemented as an external component and vice versa. Furthermore, elements may not be drawn to scale.

Example methods may be better appreciated with reference to flow diagrams. For purposes of simplicity of explanation, the illustrated methodologies are shown and described as a series of blocks. However, it is to be appreciated that the methodologies are not limited by the order of the blocks, as some blocks can occur in different orders and/or concurrently with other blocks from that shown and described. Less than all the illustrated blocks may be required to implement an example methodology. Blocks may be combined or separated into multiple components. Furthermore, additional and/or alternative methodologies can employ additional, not illustrated blocks.

FIG. 1 is a schematic diagram of a networked computing environment in which the present invention may operate.

FIG. 2 is a schematic diagram of a computing device showing the interface between the computing device and the system servers using the Internet.

FIG. 3 is a flow diagram illustrating an example embodiment of a method associated with site selection data analysis.

FIG. 4 is a flow diagram illustrating an example embodiment of a method associated with site selection data analysis.

FIG. 5 is a flow diagram illustrating an example embodiment of a wastewater estimation method that may be associated with the methods illustrated in FIG. 3 and FIG. 4.

FIG. 6 is an example interface for a selected site location for receiving site selection data.

FIG. 7 is a schematic diagram of a system associated with site selection data analysis.

### DETAILED DESCRIPTION OF THE INVENTION

The following includes definitions of selected terms employed herein. The definitions include various examples or forms of components that fall within the scope of a term and that may be used for implementation. The examples are not intended to be limiting.

References to “one embodiment”, “an embodiment”, “one example”, “an example”, and so on, indicate that the embodiment(s) or example(s) so described may include a particular feature, structure, characteristic, property, element or limitation, but not that every embodiment or example necessarily includes that particular feature, structure, characteristic, property, element or limitation.

In some examples, “database” is used to refer to a table. In other examples, “database” may be used to refer to a set of tables. In other examples, “database” may refer to a set of data stores and methods for accessing and/or manipulating those data stores.

“Data store”, as used herein, refers to a physical and or logical entity that can store data. A data store may be, for example, a database, tables, a file, a data structure, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software-controlled microprocessor, a discrete logic, an analog circuit, a digital circuit, a programmed logic device, a memory device containing instructions, and so on. Logic may include one more gates, combinations of gates, or other circuit components.

“Software”, as used herein, includes but is not limited to, one or more executable instructions that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“Query”, as used herein, refers to a semantic construction that facilitates gathering and processing information. A query may be formulated in a database query language (e.g., SQL), an Object Query Language, a natural language, and so on.

Embodiments of the invention also relate to program instructions or code for performing various computer implemented operations based on the methods and the processes of the invention. The media and program instructions may be those specifically designed and constructed for the embodiments of the invention, or they may be of the kind well-known and available to those having ordinary skill in the computer software arts. Examples of program instructions include both machine code, such as produced by a computer, and files containing a high level code that can be executed by the computer using an interpreter.

“User”, as used herein, includes but is not limited to one or more persons, software, logics, computers, or other devices and combinations of these.

The terms “contain”, “store”, and so on, as employed herein, are not intended to limit a storing element to directly hold a stored element or a contained element. A storing element may hold an identifier (e.g. a pointer) that indicates a location of a stored element. A storing element may also hold an identifier that indicates a location of a data structure that holds the stored element.

To the extent that the term “includes” or “including” is used herein, it is intended to be inclusive in a manner similar to the term “comprising” as that term is interpreted when used as a transitional word in a claim. While example systems, methods, and so on have been illustrated by describing examples, and while the examples have been described in considerable detail, it is not the intention of the Applicant to restrict or in any way limit the scope of the amended claim.

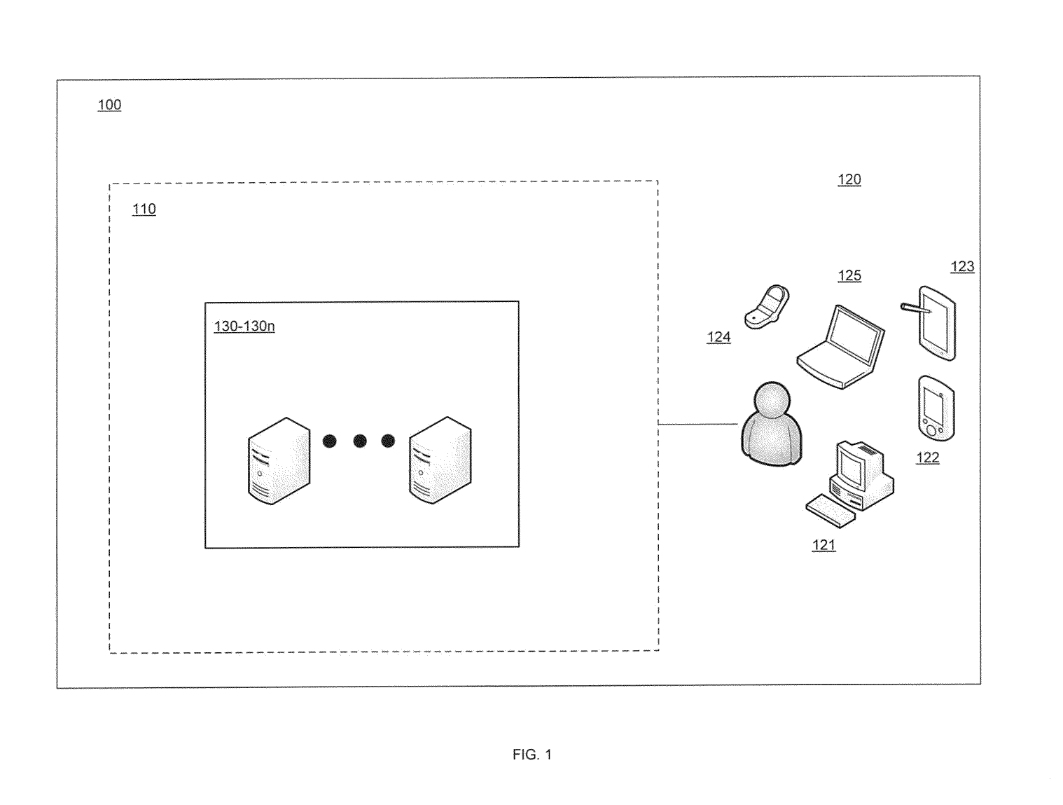

FIG. 1 is schematic diagram of a networked computing environment 100 in which the present invention may operate. End users access and browse the Internet 110 through a network using a web browser that generally resides and is executed on an end user device 120. The network may be a local area network (LAN), a wide area network (WAN) or other type of network. An end user device 120 may be a computing device, for example, a personal computer (PC). A PC will be used for purposes of explaining various embodiments herein, however, one having ordinary skill in the art will appreciate that an end user device 120 may also include a laptop, a tablet, a personal digital assistant (PDA), a mobile device or any other type of computing device. A web browser is a computer program or a set of computer instructions that allows the user to retrieve and render content from one or more servers 130-130n available over the Internet 110. Servers 130-130n may also be used as databases or data stores. Suitable commercially available web browsers include Microsoft Internet Explorer, Google Chrome Browser, Mozilla Firefox and Apple's Safari Web Browser.

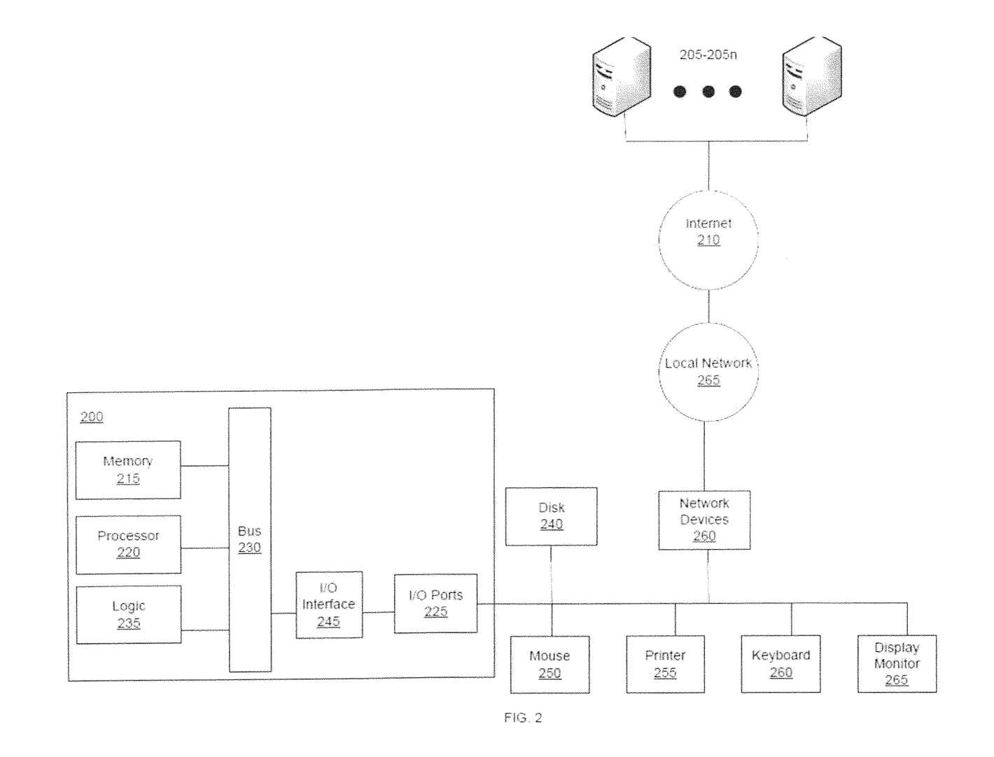

FIG. 2 is a schematic diagram of an example computing device 200, such as a user PC or an end user device 120 in FIG. 1, and the interface between the computing device 200 and the network computer system servers 205-205n using the Internet 210. Computing device 200 includes a memory 215, a processor 220, input/output (I/O) ports 225 and I/O interfaces 245 operably connected by a bus 230. In one example, the computer may include a logic 235 configured to facilitate site selection data analysis. In different examples, the logic 235 may be implemented in hardware, software, firmware, and/or combinations thereof. The logic may also be implemented in processor 220. In other examples, the logic 235 may be implemented as an application-specific integrated circuit (ASIC) programmed to control site selection data analysis or as computer executable instructions that are temporarily stored in memory 215 and executed by processor 220.

The processor 220 may be a variety of processors including dual microprocessors and other multi-processor architectures. A memory 215 may include volatile and/or non-volatile memory. Non-volatile memory may include, for example, ROM. Volatile memory may include, for example, RAM, SRAM, DRAM and so on. The memory 215 can store a process and/or data.

A disk 240 may be operably connected to the computing device 200 via an I/O interface 245 (e.g. card, driver) and an I/O port 225. The disk 240 may be for example, a floppy disk drive, a Zip drive, a flash memory card, a memory stick, a magnetic disk drive or a solid-state disk drive. The disk 240 may be a CD-ROM drive, CD-R drive, DVD drive, CD-RW drive and so on. The disk 240 and memory 215 may store an operating system that controls and allocates resources of the computing device 200.

The bus 230 may be a single internal bus interconnected architecture and/or other bus or mesh architectures. While a single bus is illustrated, the computing device may communicate with various device, logics and peripherals using other busses. The bus 230 may be a memory bus, a memory controller, a peripheral bus, an external bus, a crossbar switch, and/or a local bus.

The computing device 200 may interact with I/O devices via the I/O interfaces 245 and the I/O ports 225. I/O devices may be, for example, mouse 250, keyboard 260, printer 255, display monitor 265, network devices 260. The I/O ports may be a serial port, a parallel port, a USB port. Display monitor 265 may include a display monitor on a PC. Information in text, graphic and other forms is displayed on the display monitor 265 under the control of processor 220.

The computing device 200 can operate in a network environment and thus may be connected to the network device 260 via the I/O interfaces 245 and/or the I/O ports 225. Through the network device 260, the computer may interact with a network 265. Through the network 265, the computer may be logically connected to the Internet 210, servers 205-205n and other remote computers. Networks with which the computer may interact include, but are not limited to, a LAN, WAN and other networks.

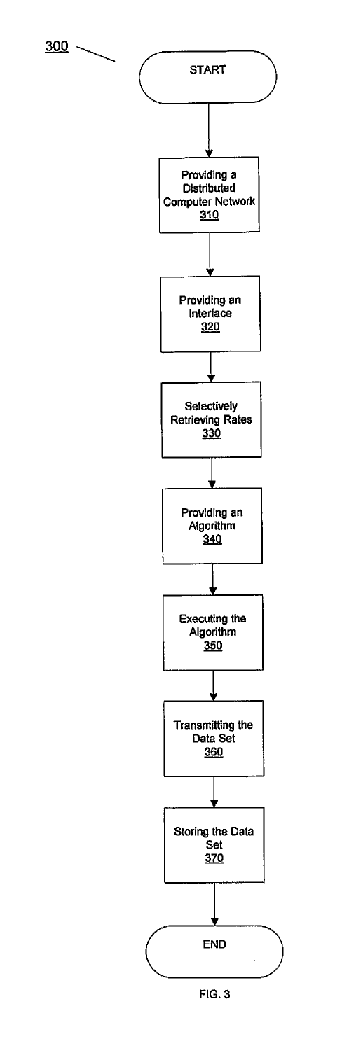

FIG. 3 illustrates an example embodiment of a computer-implemented method 300 for site selection data analysis in a networked computing environment. Method 300 facilitates the site selection process for a decision maker and facilitates data gathering for a particular location. For example, the decision maker may be the president of a company looking to re-locate his business to a site location in a community ABC. It is to be appreciated that the decision maker may be any type of private or public person looking for site selection data for a particular jurisdiction. For example, the decision maker may be other business personnel, consulting companies, Economic Development Agencies, persons interested in a start-up company and so on.

Method 300 includes at 310 providing a computer network comprising a computer and a plurality of databases each coupled to a computer network. The decision maker may use a PC as the computer to access a network and connected servers or databases. Referring to FIG. 1, networked computer system 100 is an example of a computer network in which the present invention may operate. End user devices 120 may represent the client computer. Additionally, servers 103-103n may be a plurality of databases each coupled to a computer network. The client computer, or other end user device, can access the databases through the computer network using WAN, LAN or other computer network technologies known in the art.

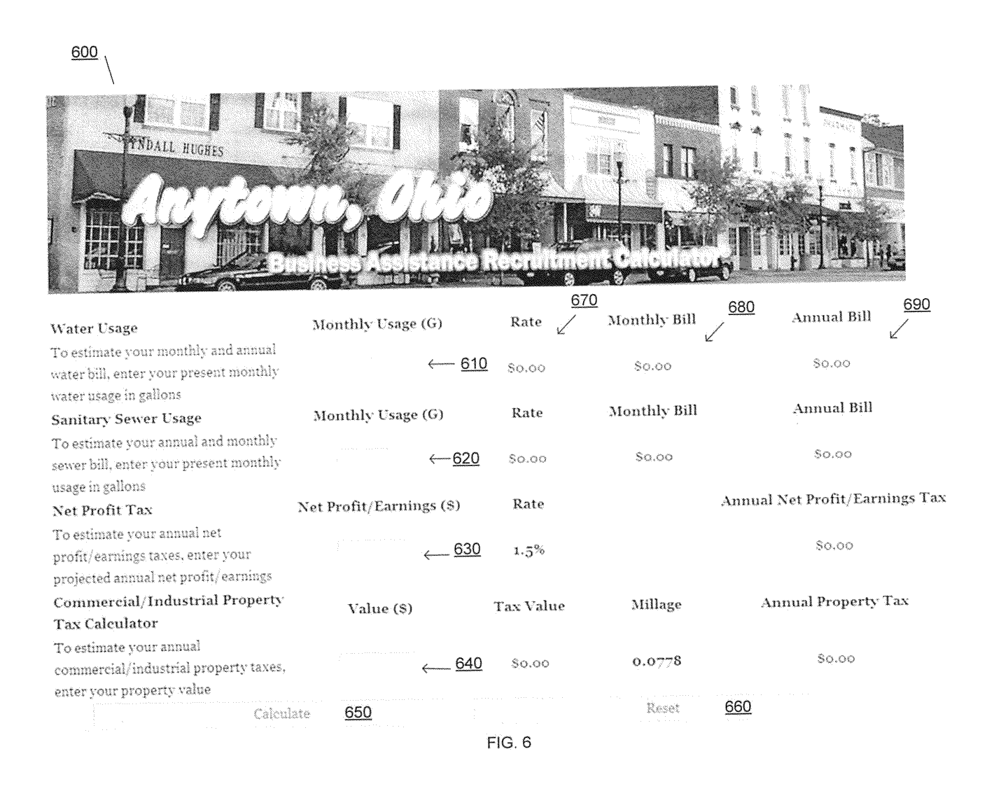

Method 300 also includes at 320 providing an interface for a site location for receiving site selection data from the computer. This interface may include a web form presented to the computer. The web form can be written in HTML, CSS, PHP, JAVA, XML or another suitable programming language. An interface as shown in FIG. 6 may be provided to the computer. The interface facilitates receiving site selection data. A user may input the site selection data into the interface, for example, by using a keyboard. Referring back to the example above, the decision maker may browse the internet using a commercially available browser to search for community ABC's website. Community ABC may provide an HTML web form to the decision maker and decision maker can input site selection information into the interface.

Site selection data may include quantifiable values associated with business operating expenses. For example, quantifiable values may include water usage, electricity usage, natural gas usage, net profit, property value, wastewater usage and business units. Water usage is a monthly water usage value measured in gallons (G). Electricity usage is a monthly electricity usage value measured in kilowatts (kW). Natural gas usage is a monthly natural gas usage value measured in British Thermal Units (BTUs). Net profit is the projected annual net profit/earnings for a particular business. Property value is the monetary value of a piece of property based on the amount a buyer will pay at any given time or the amount appraised by a governing authority. Wastewater usage is a monthly wastewater, or sanitary sewer water, usage value measured in gallons (G).

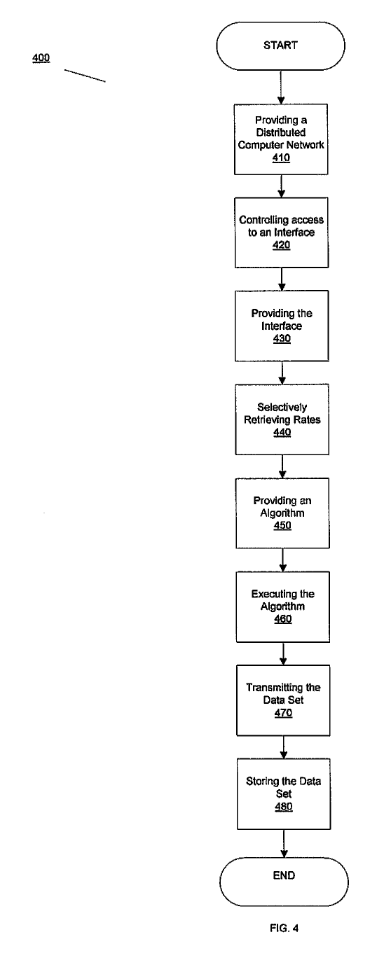

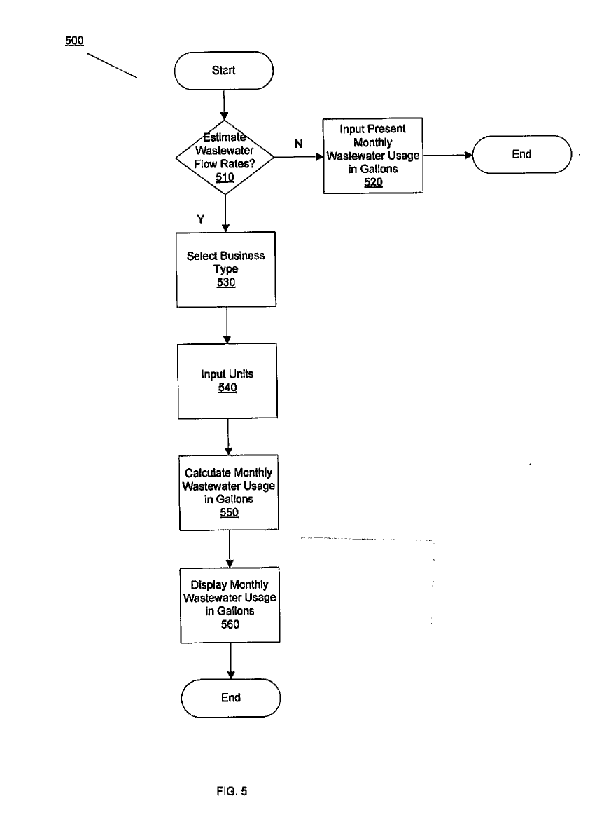

The wastewater usage may be input by the user or estimated as shown in FIG. 5. Method 500 can provide estimated wastewater flow rates based at least upon business type and business units in accordance with the EPA Typical Wastewater Flow Rates from Commercial Sources (http://www.epa.gov/nrmrl/pubs/625r00008/html/625R00008chap3.htm). If the user chooses not to estimate wastewater usage at 510, the user then inputs the present monthly wastewater usage in gallons at 520. If a user chooses to estimate wastewater usage at 510, the user then selects a business type at 530. The business type refers to a type of facility such as a restaurant, a hotel, a department store, a shopping center and so on. At 540, the user enters the number of business units. Units may refer to the number of customers, employees, people occupying the facility or the number of seats in a facility. At 550, the monthly wastewater usage in gallons is calculated by generating a query, for example in SQL, based at least upon the selected business type and the business units. The query is executed on a database to return the monthly wastewater usage in gallons. At 560, the monthly wastewater usage in gallons is displayed. The value calculated at 550 may be used further in the methods described in FIG. 3 and FIG. 4.

Method 300 also includes at 330 selectively retrieving one more rates from a rate database, where the rates are selected based on the site location and site selection data, where the rates are updated dynamically. A rate may be a county property tax, a cost per gallon of water, a cost per unit of electricity, an income tax and so on. Each rate, for each location is stored in a rate database and selectively retrieved based on the site selection data and site location. A rate may depend on the usage entered into the interface by the user. For example, wastewater of 300 gallons or less may be associated with a lower rate than wastewater greater than 300 gallons. Rates are also dynamically updated, for example, by automatically acquiring new rate information from a database to keep rate information in a current and relevant condition.

Method 300 includes at 340 providing one or more algorithms for calculating monthly and annual values of the site selection data. The algorithm is based at least upon the site location, the site selection data and the rates. The following are examples of algorithms that may be provided:

Monthly Water Usage (G)×Water Rate=Monthly Water Bill

Monthly Water Bill×12=Annual Water Bill

Monthly Wastewater Usage (G)×Wastewater Rate=Monthly Wastewater Bill

Monthly Wastewater Bill×12=Annual Wastewater Bill

Net Profit/Earnings ($)×Income Tax Rate=Annual Net Profit/Earnings Tax

Property Value ($)×Property Tax Rate=Annual Property Tax

Monthly Electric Usage (kW)×Electric Rate=Monthly Electric Bill

Monthly Electric Bill×12=Annual Electric Bill

Method 300 includes at 350 executing the one or more algorithms to produce a data set of results. The algorithm may be in the form of a query executed on a database. The result of the algorithm is stored in a data set. The data set may be an abstract data structure that can store values. For example, the data set may be a list, tree, hash table and so on.

Method 300 also includes at 360 transmitting the data set to the computer to be displayed on a display device. The data set may be displayed on an end user device screen. The data set may be used to generate a report, which can be displayed on a display device and then printed by the user on a printer. The data set may also be exported to a commercial computer application such as Microsoft Excel. Method 300 is also capable of sending the data set to a remote site, such as a Geographic Information System (GIS) site, using, for example, an application program interface (API).

Method 300 also includes at 370 storing the data set and site selection data on a data storage device. The stored data may be used by a particular jurisdiction. For example, the stored data may be used to generate a report with a summary of stored data sets and site selection data associated with a jurisdiction. The report may be formatted for different applications, for example the report may be displayed on the web in a browser, the report may be operable with Adobe PDF, Microsoft Word, Microsoft Excel and so on. The report is useful for infrastructure evaluation, planning, budgeting and grant application purposes.

Referring back to the example above, the present invention calculates and provides to the decision maker comprehensive and current site selection values in a meaningful and accessible format. The non-identifying data and calculated values are stored for future use by Community ABC. Community ABC can then generate a report with a summary of all data and calculated values stored for Community ABC. For example, the report could display an average of all electricity usage data. This information could be used for electricity load forecasting and infrastructure evaluation. Appropriate changes can also be made to relevant policies and financial plans. Thus, this data allows Community ABC to accommodate the needs of prospective businesses and therefore facilitates Community ABC's economic development recruitment and retention.

FIG. 4. illustrates an example embodiment of a computer-implemented method 400 for site selection data analysis. Method 400 may be used in subscription-based services for site selection data analysis. For example, a consulting firm or an Economic Development Agency may want to compare site selection data for multiple jurisdictions.

Method 400 is similar to method 300. For example, method 400 includes at 410 providing a computer network comprising a computer and a plurality of databases each coupled to a computer network. Method 400 also includes at 420 controlling access to an interface by authenticating the computer and permitting access to the interface. The authentication of the computer or user of the computer utilizes standard authentication protocols that are well known in the prior art. Based on the user's credentials, such as login name and password, the method controls access and allows the user to access the proper interface.

In response to the authentication, method 400 also includes at 430 providing an interface for receiving site selection data. An interface as shown in FIG. 6 may be provided to the computer.

Site selection data may include, but is not limited to water usage, electricity usage, natural gas usage, net profit, property value, wastewater usage, business type and business units. Water usage is a monthly water usage value measured in gallons (G). Electricity usage is a monthly electricity usage value measured in kilowatts (kW). Natural gas usage is a monthly natural gas usage value measured in British Thermal Units (BTUs). Net profit is the projected annual net profit/earnings for a particular business. Property value is the monetary value of a piece of property based on the amount a buyer will pay at any given time or the amount appraised by a governing authority. Wastewater usage is a monthly wastewater, or sanitary sewer water, usage value measured in gallons (G). Additionally, multiple interfaces may be provided for multiple site locations. It is to be appreciated that wastewater may be estimated as illustrated and described in FIG. 5.

Similar to method 300, method 400 includes at 440 selectively retrieving rates from a rate database, where the rates are associated with the site location and site selection data, and where the rates are updated dynamically. A rate may be a county property tax, a cost per gallon of water, a cost per unit of electricity, an income tax and so on. Each rate, for each location is stored in a rate database and selectively retrieved based on the site selection data and site location. A rate may depend on the usage entered into the interface by the user. For example, wastewater of 300 gallons or less may be associated with a lower rate than wastewater greater than 300 gallons. Rates are also dynamically updated, for example, by automatically acquiring new rate information from a rate database to keep rate information in a current and relevant condition.

Similar to method 300, method 400 includes at 450 providing an algorithm for calculating monthly and annual values for the site selection data. The algorithm is based at least upon the site location, the site selection data and the rates. The following are examples of algorithms that may be provided:

Monthly Water Usage (G)×Water Rate=Monthly Water Bill

Monthly Water Bill×12=Annual Water Bill

Monthly Wastewater Usage (G)×Wastewater Rate=Monthly Wastewater Bill

Monthly Wastewater Bill×12=Annual Wastewater Bill

Net Profit/Earnings ($)×Income Tax Rate=Annual Net Profit/Earnings Tax

Property Value ($)×Property Tax Rate=Annual Property Tax

Monthly Electric Usage (kW)×Electric Rate=Monthly Electric Bill

Monthly Electric Bill×12=Annual Electric Bill

Method 400 includes at 460 executing the algorithm. The algorithm may be in the form of a query executed on a database. The result of the algorithm is stored in a data set. The data set may be an abstract data structure that can store certain values. For example, the data set may be a list, tree, hash table and so on.

Method 400 includes at 470 transmitting the data set to the client computer to be displayed on a display device. Additionally, the data set for multiple site locations can be displayed on a display device for comparison. The data set may be displayed on an end user device screen. The data set may be used to generate a report that can be displayed on a display device and then printed by the user on a printer. The data set may also be exported to a commercial computer application such as Microsoft Excel. Method 400 is also capable of sending data to a remote site, such as a GIS site, using, for example, an API.

Method 400 includes at 480 storing the data set and site selection data on a data storage device. The stored data may be used by a particular site location or community. For example, the stored data may be used to generate a report that summarizes the stored data sets and site selection data associated with a site location. The report may be formatted for different applications, for example the report may be displayed on the web in a browser, the report may be operable with Adobe PDF, Microsoft Word, Microsoft Excel and so on. The report is useful for infrastructure evaluation, planning, budgeting and grant application purposes.

FIG. 6 is an example interface for a selected site location for receiving site selection data. Interface 600 may be used with the methods illustrated in FIG. 3 and FIG. 4. Interface 600 may be a Web interface displayed on a computing device. A user operating the computing device may input site selection data from the computing device. For example, a user may input the monthly usage of water in gallons in element 610. A user may input monthly sanitary sewer usage or wastewater usage in gallons in element 620. A user may input projected annual net profit/earnings in element 630. A user may input an estimated property value in element 640. It is to be appreciated that the interface may employ various designs and formats. The interface may also include other economic data consistent with the present invention.

After the user has input the site selection data, the user may choose to “Calculate” the associated costs by selecting element 650. Element 650 will trigger a script to provide and execute the appropriate algorithms discussed above with step 640. The resulting data set is displayed in columns 670, 680 and 690. Column 670 represents the rates associated with the site selection data. For example, the rate 1.5% is associated with net profit tax/earnings. Column 680 lists the monthly bill or millage associated with the site selection data and rates. Column 690 lists the annual bill/costs associated with the site selection data and rates.

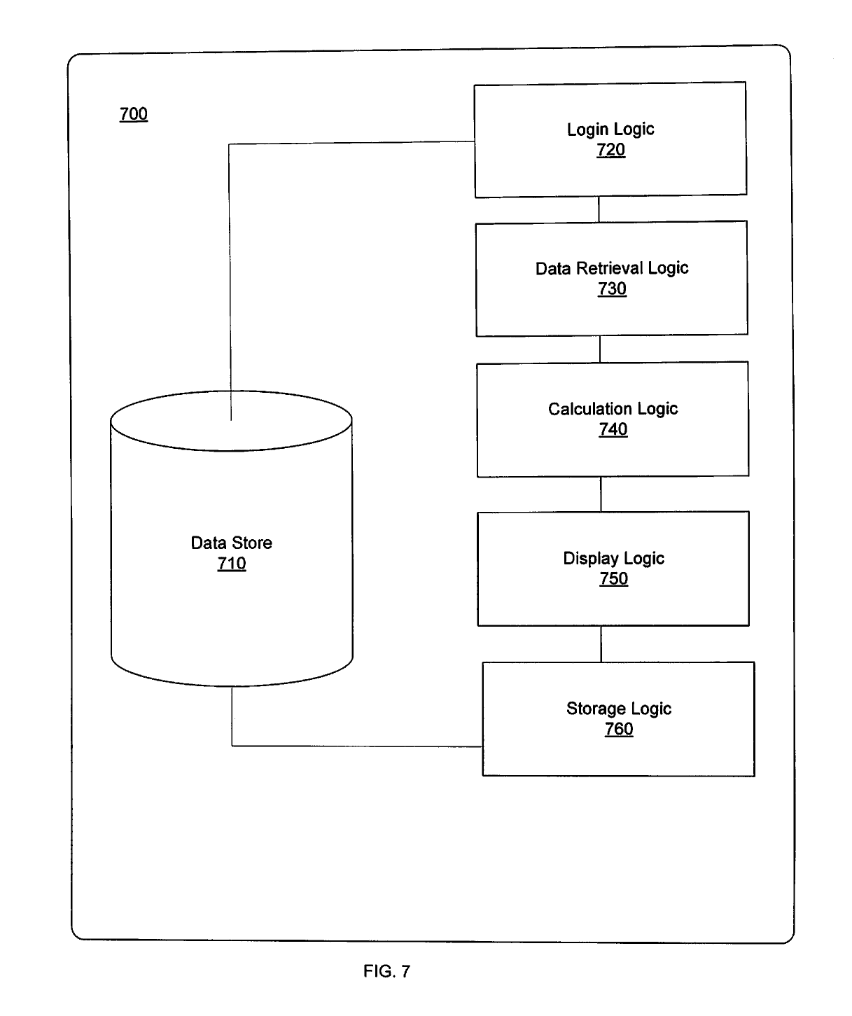

According to another embodiment of the present invention, FIG. 7 is a schematic diagram of a system 700 associated with site selection data analysis. System 700 includes a login logic 720, data retrieval logic 730, a calculation logic 740, a display logic 750 and a storage logic 760 that all access a data store 710 to retrieve and store data.

System 700 includes a login logic 720 for authenticating a client and permitting access to an interface for pre-determined jurisdictions. The authentication of the computer or user of the computer utilizes standard authentication protocols that are well known in the prior art. Based on the user's credentials, such as login name and password, the system controls access and allows the user to access the proper interface for pre-determined jurisdictions. This type of login logic facilitates subscription-based service for site selection data analysis. For example, a consulting firm or an Economic Development Agency may be authorized to view site selection data for certain pre-determined jurisdictions.

The system also includes a data retrieval logic 730 that retrieves, upon authentication of the client, at least one site location, a business type, and data based at least upon the site location and rates associated with the data from a plurality of databases, where the databases are dynamically updated. A site location may represent a specific jurisdiction. The business type refers to a type of facility such as a restaurant, a hotel, a department store, a shopping center and so on.

The data may include, but is not limited to water usage, electricity usage, natural gas usage, net profit, property value, wastewater usage and business units. Water usage is a monthly water usage value measured in gallons (G). Electricity usage is a monthly electricity usage value measured in kilowatts (kW). Natural gas usage is a monthly natural gas usage value measured in British Thermal Units (BTUs). Net profit is the projected annual net profit/earnings for a particular business. Property value is the monetary value of a piece of property based on the amount a buyer will pay at any given time or the amount appraised by a governing authority. Wastewater usage is a monthly wastewater, or sanitary sewer water, usage value measured in gallons (G). The wastewater usage may be input by a user or estimated as described above and shown in FIG. 5.

A rate may be a county property tax, a cost per gallon of water, a cost per unit of electricity, an income tax and so on. Each rate, for each location is stored in a rate database and selectively retrieved based on the site selection data and site location. A rate may depend on the usage entered into the interface by the user. For example, wastewater of 300 gallons or less may be associated with a lower rate than wastewater greater than 300 gallons. Rates are also dynamically updated, for example, by automatically acquiring new rate information from a database to keep rate information in a current and relevant condition.

System 700 also includes a calculation logic 740 that provides an algorithm based at least upon the values and rates, where the calculation logic executes the algorithm to produce a data set. The following are examples of algorithms that may be provided:

Monthly Water Usage (G)×Water Rate=Monthly Water Bill

Monthly Water Bill×12=Annual Water Bill

Monthly Wastewater Usage (G)×Wastewater Rate=Monthly Wastewater Bill

Monthly Wastewater Bill×12=Annual Wastewater Bill

Net Profit/Earnings ($)×Income Tax Rate=Annual Net Profit/Earnings Tax

Property Value ($)×Property Tax Rate=Annual Property Tax

Monthly Electric Usage (kW)×Electric Rate=Monthly Electric Bill

Monthly Electric Bill×12=Annual Electric Bill

The algorithm may be in the form of a query executed on a database. The result of the algorithm is stored in a data set. The data set may be an abstract data structure that can store values. For example, the data set may be a list, tree, hash table and so on.

System 700 also includes a display logic 750 that provides a visual representation of the site selection data set on a display device. The data set may be displayed on an end user device screen. The data set may be used to generate a report that can be displayed on a display device and then printed by the user on a printer. The data set may also be exported to a commercial computer application such as Microsoft Excel. System 700 is also capable of sending data to a remote site, such as a GIS site, using, for example, an API.

System 700 also includes a storage logic 760 that stores the site selection data set in a data store. System 700 may further include a report logic that generates a report with a summary of stored data sets and values associated with a site location. The report may be formatted for different applications, for example the report may be displayed on the web in a browser, the report may be operable with Adobe PDF, Microsoft Word, Microsoft Excel and so on. The report is useful for infrastructure evaluation, planning, budgeting and grant application purposes. The report logic may also generate a listing of one more rates for one more site locations to a user.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A computer-implemented method for site selection data analysis, comprising:
providing a distributed computer network for site selection data analysis comprising a computer and a plurality of databases each coupled to a computer network;
providing an interface associated with a selected site location for receiving site selection data from the computer, wherein the site selection data comprises quantifiable values associated with business operating expenses;
selectively retrieving rates from a rate database, wherein the rates are selected based on the site location and site selection data, and including rate databases wherein the rates are updated dynamically;
providing an algorithm for calculating monthly and annual values of the site selection data and calculating a data set using the algorithm;
transmitting the data set to the computer to be displayed on a display device; and
storing the data set and site selection data on a data storage device.

2. The method of claim 1, wherein a user inputs the site selection data into the interface.

3. The method of claim 1, wherein providing the algorithm includes generating a algorithm based at least upon the rates and site selection data.

4. The method of claim 1, wherein the quantifiable values associated with business operating expenses comprise water usage, electricity usage, natural gas usage, net profit, property value, wastewater usage and business units.

5. The method of claim 4, wherein wastewater usage is calculated by generating a query based at least upon the a selected business type and the business units and executing the query on a database.

6. The method of claim 1, further comprising generating a report with a summary of stored data sets and site selection data associated with the site location.

7. The method of claim 1, wherein the interface is presented as a module in a geographic information system through an application programming interface.

8. A computer-implemented method for site selection data analysis, comprising:
providing a distributed computer network for site selection data analysis comprising a computer and a plurality of databases each coupled to a computer network;
controlling access to an interface by authenticating the computer and permitting access to the interface;
providing the interface to the computer for receiving at least one site location and site selection data from a user, wherein the site selection data comprises water usage, electricity usage, natural gas usage, net profit, property value, wastewater usage, business type and business units;
selectively retrieving rates from a rate database, wherein the rates are associated with the site location and site selection data, and where the rates are updated dynamically;
providing an algorithm, based on the rates and site selection data, for calculating monthly and annual values of the site selection data and calculating a data set using the algorithm;
transmitting the data set to the computer to be displayed on a display device; and
storing the data set and site selection data on a data storage device.

9. The method of claim 8, wherein the user inputs the site selection data into the interface.

10. The method of claim 8, wherein providing the algorithm includes generating an algorithm based at least upon the rates and site selection data.

11. The method of claim 8, wherein wastewater usage is calculated by generating a query, based at least upon the selected business type and the business units and executing the query on a database.

12. The method of claim 8, wherein the data set for each site location is displayed on the display device for comparison.

13. The method of claim 8, further comprising generating a report with a summary of stored data sets and site selection data associated with the site location.

14. The method of claim 8, wherein the interface is presented as a module in a geographic information system through an application programming interface.

15. A computing system for site selection data analysis in a networked computing environment comprising:
a login logic for authenticating a client and permitting access to an interface for pre-determined jurisdictions;
a data retrieval logic that retrieves, upon authentication of the client, at least one site location, values associated with business operating expenses, rates associated with the site location and values from a plurality of databases, wherein the databases are dynamically updated;
a calculation logic that provides a algorithm based at least upon the values and rates, where the calculation logic executes the algorithm to produce a data set;
a display logic that provides a visual representation of the data set on a display device; and
a storage logic that stores the data set and values in a data store.

16. The system of claim 15, wherein the client is identified by client information stored in a client database.

17. The system of claim 15, wherein the visual representation comprises a data list, a chart or a spreadsheet.

18. The system of claim 15, further including a report logic that generates a report with a summary of stored data sets and values associated with the site location.

19. The system of claim 15, wherein the report logic includes generating a rate report listing one or more rates for one or more site locations.

20. The system of claim 15, wherein the values comprises water usage, wastewater usage, electricity usage, natural gas usage, net profit, property value, business type and business units.
